(19) United States
(12) Patent Application Publication
(10) Pub. No.: US 2026/0295640 A1
(43) Pub. Date: Oct. 1, 2026

(54) MATERIAL TYPE DETERMINATION SYSTEM, SORTING SYSTEM, AND METAL MATERIAL PRODUCTION METHOD

(71) Applicant: HONDA MOTOR CO., LTD., Tokyo (JP)

(72) Inventors: Hideki KUBOTANI, Wako-shi (JP); Akihiko ASAMI, Wako-shi (JP); Yoshitaka OKITSU, Wako-shi (JP)

(21) Appl. No.: 19/572,074

(22) Filed: Mar. 19, 2026

(30) Foreign Application Priority Data
Mar. 28, 2025 (JP) 2025-055454

(51) Int. Cl. B07C 5/04

(52) U.S. Cl. CPC B07C 5/04

(57) ABSTRACT

A material type determination system includes a hardware processor. The hardware processor is configured, as a construction part, to: determine, for each material type of a crushed piece that is made of metal, a crushed shape of the crushed piece by a virtual method; and, from the determined crushed shape for each material type, construct a machine learning model whose explanatory variable is a crushed shape and whose target variable is a material type of the crushed piece. The hardware processor is configured, as a determination part, to determine, from the machine learning model and a crushed shape of the crushed piece that has actually been obtained, a material type of the obtained crushed piece.

### CROSS-REFERENCE STATEMENT

The present application is based on, and claims priority from, Japan Application Serial Number 2025-055454, filed Mar. 28, 2025, the disclosure of which is hereby incorporated by reference herein in its entirety.

### BACKGROUND

### Technical Field

The disclosure relates to a material type determination system, a sorting system, and a metal material production method.

### Related Art

Japanese Patent Application Publication Number 2023-157278 (hereinafter “Patent Literature 1”) discloses “A determination device comprising: a camera that photographs a crushed piece of metal and generates a crushed piece image including the crushed piece; and a controller that determines a content ratio of an added metal in the crushed piece appearing in the crushed piece image based on the crushed piece image generated by the camera, wherein, the controller includes a determination model constructed through machine learning of a crushed piece image for learning and an index indicating the content ratio of the added metal in the crushed piece appearing in the crushed piece image, and the controller determines the content ratio of the added metal in the crushed piece based on an output result obtained by inputting the crushed piece image generated by the camera into the determination model”.

In the invention described in Patent Literature 1, a machine learning model for determining a metal composition of a crushed piece is constructed using crushed piece images that have actually been captured (paragraph [0025] of Patent Literature 1). However, among metal compositions determined from a required physical property such as required strength of a metal structure, there may be a metal composition that meets the required physical property but is not actually used, or a metal composition that is used but is rarely used. In these cases, a new metal structure has to be produced and then crushed, which takes time and effort.

### SUMMARY

An aspect of the disclosure provides a material type determination system including a hardware processor. The hardware processor is configured, as a construction part, to: determine, for each material type of a crushed piece that is made of metal, a crushed shape of the crushed piece by a virtual method; and, from the determined crushed shape for each material type, construct a machine learning model whose explanatory variable is a crushed shape and whose target variable is a material type of the crushed piece. The hardware processor is configured, as a determination part, to determine, from the machine learning model and a crushed shape of the crushed piece that has actually been obtained, a material type of the obtained crushed piece. Other solutions will be described later in the description of embodiments.

### BRIEF DESCRIPTION OF DRAWINGS

FIG. 1 is a schematic diagram of a sorting system according to an embodiment of the disclosure.

FIG. 2 is a block diagram of a material type determination system according to an embodiment of the disclosure.

FIG. 3 is a schematic diagram of a shape database.

FIG. 4 is a flowchart showing a method of constructing a machine learning model in a case where labeling is performed.

FIG. 5 is a schematic diagram of a product database.

FIG. 6 is a flowchart showing a method of constructing a machine learning model in a case where labeling is not performed.

FIG. 7 is a block diagram showing a specific hardware configuration of the material type determination system.

FIG. 8 is a flowchart showing a metal material production method according to an embodiment of the disclosure.

### DETAILED DESCRIPTION

Hereinafter, modes (referred to as embodiments) for carrying out the disclosure will be described with reference to the drawings. The following content is merely an example for carrying out an embodiment of the disclosure, and the disclosure is not limited to the following example. In the following description of one embodiment, a description of another embodiment applicable to the one embodiment will be provided as appropriate. The disclosure is not limited to the following embodiment, and different embodiments may be combined with each other, or the embodiment may be modified within a range that does not significantly impair the effect of the disclosure. The same members are denoted by the same reference signs and repeat description will be omitted. Further, the same names are given to those having the same functions. Contents shown in the drawings are merely schematic, and for convenience of illustration, an actual configuration may be changed within a range that does not significantly impair the effect of the disclosure, or a member may be omitted or modified between the drawings. The same embodiment may not necessarily include all the configurations.

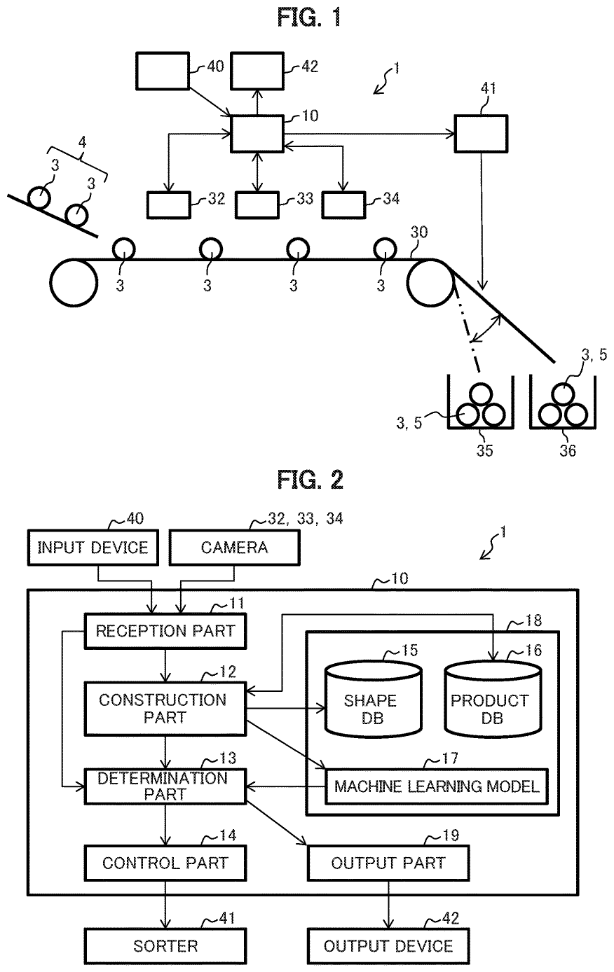

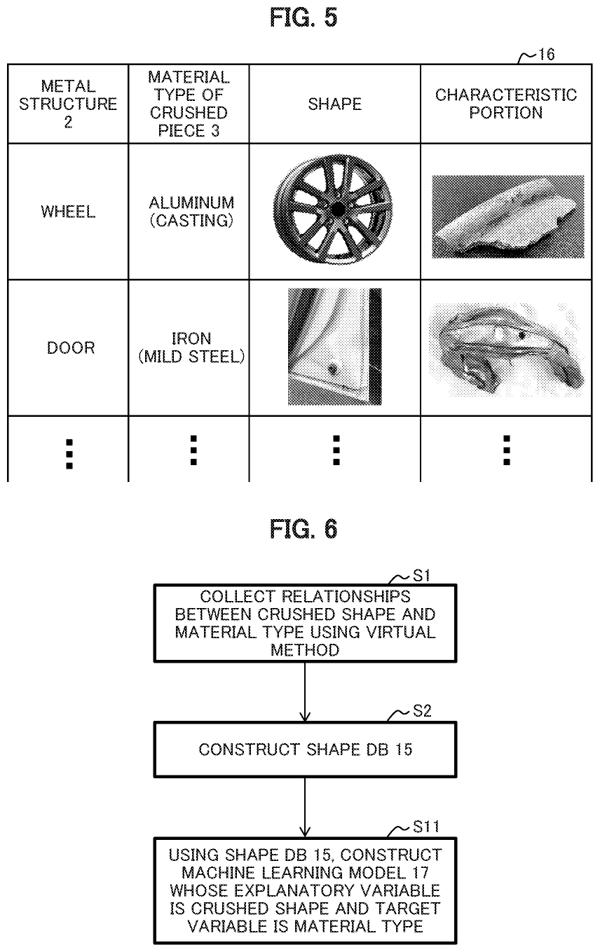

FIG. 1 is a schematic diagram of a sorting system 1 according to an embodiment of the disclosure. The sorting system 1 is a system that sorts crushed pieces 3 by material type from a mixture 4 of crushed pieces 3 of a plurality of types of metal structures 2 (FIG. 5). A metal structure 2 is, for example, a component mounted on a vehicle. A specific example of the metal structure 2 may be a component such as a metal wheel or a metal door shown in FIG. 5 (to be described later). The plurality of types means that a material type (a type of a constituent element, a concentration of a constituent element, or the like) is different and may not necessarily mean that types of the metal structures 2 are also different. Therefore, in an example of the disclosure, even when the types of the metal structures 2 are different, the metal structures 2 are referred to as being the same type when the material types are the same, and even when the types of the metal structures 2 are the same, the metal structures 2 are referred to as being different types when the material types are different.

By sorting crushed pieces 3 of a plurality of types of metal structures 2 by material type, that is, by sorting a plurality of types of crushed pieces 3 by material type, recycling of sorted crushed pieces 3 may become possible. That is, for example, in a case of crushed pieces 3 obtained by crushing a wheel made of cast aluminum, the cast aluminum may be collected by sorting and the collection may be recast, whereby a wheel made of cast aluminum may be manufactured again. This enables the execution of so-called “horizontal recycling” or closed-loop recycling. Therefore, a sorting method of the disclosure executed using FIG. 1 may be said to be a method for producing metal material 5 that may be used in a method for producing a component (which may be a finished product) in horizontal recycling or the like.

The sorting system 1 includes a material type determination system 10, a belt conveyor 30, a camera 32, 33, 34, an input device 40, a sorter 41, and an output device 42. The material type determination system 10 is a system (a determination device) that determines a material type of a crushed piece 3 moving on the belt conveyor 30 using information obtained from the camera 32, 33, 34. For convenience, the belt conveyor 30, the camera 32, 33, 34, the input device 40, the sorter 41, and the output device 42 will be described prior to describing the material type determination system 10.

Crushed pieces 3 of the mixture 4 move one by one along the belt conveyor 30 (the crushed pieces 3 are transferred one by one over the belt conveyer 30). In one or more embodiments, a method may be used in which a plurality of crushed pieces 3 are arranged across a width of the belt conveyor 30, the plurality of crushed pieces 3 are captured in one image, and then position information and an optical image, X-ray information, or infrared information are obtained for each individual pieces of the plurality of crushed pieces 3. The crushed pieces 3 may be obtained by crushing a metal structure 2 retrieved, for example, as a used product or a waste product, and using a crushing device such as an industrial shredder. The crushed pieces 3 moving on the belt conveyor 30 are photographed using at least one (one or two, or all) of an optical camera 32, an infrared camera 33, or an X-ray irradiating camera 34 for example. For example, the camera 34 includes an X-ray source, and an X-ray detector (not shown; may be a line sensor, two-dimensional image sensor, or the like) is provided on a side opposite to the camera 34, with the belt conveyor 30 in between. The obtained information is input to a reception part 11 (to be described later) of the material type determination system 10. In this way, the material type determination system 10 may identify a three-dimensional shape (including a size, a thickness, or the like) of a crushed piece 3 and a position of the crushed piece 3 on the belt conveyor 30.

The input device 40 is a device that may input various types of information to the material type determination system 10. Information that is input is received by the reception part 11, which will be described later. The input information is, for example, information that is stored in a shape database (shape DB) 15 (to be described later) or a product database (product DB) 16 (to be described later), information used to construct a machine learning model 17, information used to operate the sorting system 1, or the like. The input device 40 is, for example, a keyboard, a mouse, a touch panel, or the like.

The sorter 41 is a mechanism that sorts crushed pieces 3 by material type in accordance with the material type that has been determined by the material type determination system 10 (particularly, a determination part 13 to be described later). The sorter 41 is controlled by a control part 14 (to be described later) included in the material type determination system 10. The sorter 41 may store the crushed pieces 3 in different containers 35, 36 that are provided for each material type by changing a tilt-up angle of a chute that the belt conveyor 30 is equipped with, for example. As a result, metal materials 5 of the same material type are sorted into a corresponding container 35 or 36. In one or more embodiments, the sorter 41 may be an air blower, a robot arm, or the like.

The output device 42 is, for example, a device that outputs the material type that has been determined by the material type determination system 10 for each of the crushed pieces. The output device 42 is, for example, a monitor, a display, a touch screen, a printer, a mobile communication terminal, or the like.

FIG. 2 is a block diagram of a material type determination system 10 according to an embodiment of the disclosure. The material type determination system 10 includes the reception part 11, a construction part 12, the determination part 13, the control part 14, the shape database (DB) 15, the product database (DB) 16, the machine learning model 17, and an output part 19. In the disclosure, the machine learning model 17 is a trained model unless otherwise specified. The shape DB 15, the product DB 16, and the machine learning model 17 are stored in storage 18 that is included in the material determining system 10. At least a part of the functional parts constituting the material type determination system 10 may be stored in a server (not shown) installed at a remote location away from the sorting system 1.

An image (or a video) obtained by the camera 32, 33, 34 is input to the material type determination system 10 through the reception part 11. Information other than the image obtained by the camera 32, 33, 34 is input to the material type determination system 10 via the input device 40 and through the reception part 11.

The construction part 12 is a functional part configured to construct the machine learning model 17 from a crushed shape of a crushed piece 3 that has been determined (estimated) by a virtual method for each material type of a crushed piece 3. An explanatory variable and a target variable of the machine learning model 17 are a crushed shape and a material type of a crushed piece 3 respectively. The virtual method referred to here is a method of determining a crushed shape by virtually producing a crushed piece 3 by, for example, analysis (simulation), such as finite element method (FEM) analysis, or generative artificial intelligence (generative AI), instead of performing composition analysis (actual measurement) on an actual crushed piece 3, for example, by ICP-MS.

The finite element method (FEM) analysis is a method of modeling a crushing device that crushes a metal structure 2 (a component, finished product, or the like), which is a structure of a crushed piece 3 before crushing, and obtaining, through simulation, a crushed shape of the crushed piece 3 obtained by inputting the metal structure 2 into the crushing device. The generative artificial intelligence (generative AI) is, for example, artificial intelligence that outputs the material type of an inputted crushed piece 3 by inputting the crushed shape (a three-dimensional shape) of the crushed piece 3. In addition to the material type estimation (labeling, to be described later), the generative AI may predict a crushed shape from the material type of a crushed piece 3 to generate data of the crushed shape for training.

Metals include mechanical properties (mechanical physical properties) such as tensile strength, yield strength, and bending strength that are specific to each material type of the metal. When a metal structure 2 is crushed, a mechanical force is applied to the metal structure 2. Therefore, deformation due to application of the mechanical force, that is, the shape (crushed shape) of the crushed piece 3 varies depending on the material type. In other words, there is, in a certain sense, a correlation between the material type and the crushed shape. Therefore, in an example of the disclosure, the material type of the crushed piece 3 is determined from the crushed shape of the crushed piece 3. Further, the material type and the crushed shape are associated with each other by a virtual method such as FEM analysis or generative AI.

The construction part 12 constructs the machine learning model 17 using the shape DB 15. The shape DB 15 is a database in which the crushed shape of the crushed piece 3 determined by the virtual method is associated with the material type of the crushed piece 3.

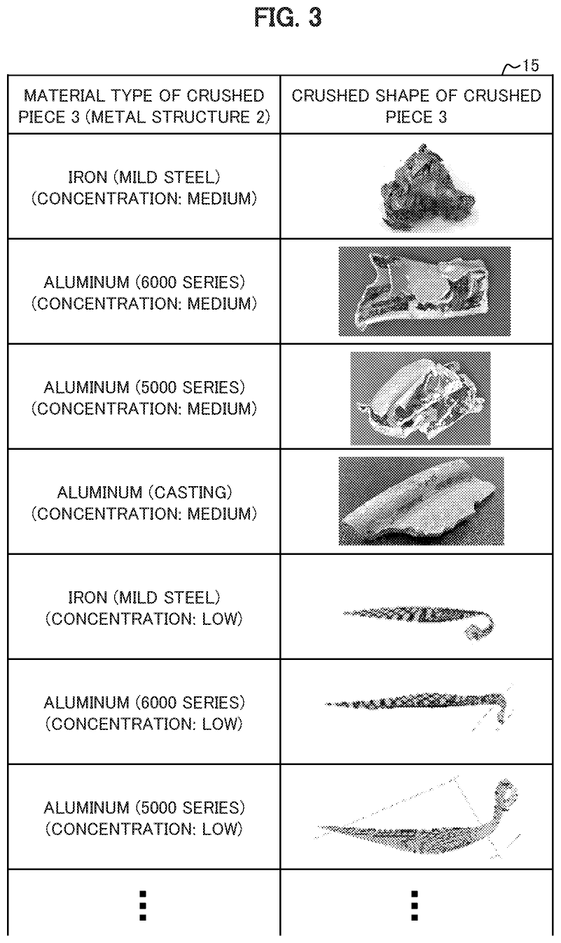

FIG. 3 is a schematic view of the shape DB 15. In the shape DB 15, for each material type of the crushed pieces 3, a crushed shape of a crushed piece 3 determined by a virtual method (for example, FEM analysis) is recorded in association with the material type. In the illustrated example, the crushed shape is an image (a photograph), but the crushed shape may be indicated, for example, in terms of characters (on a size, a structure, a color, a presence or an absence of gloss, or the like), a pattern, or the like representing the crushed shape.

In the illustrated example, the material types include iron (mild steel), aluminum (6000 series), aluminum (5000 series), aluminum (casting), and the like. Even when the types of metal (iron, aluminum, or the like) of crushed pieces 3 are the same, the crushed shapes may vary depending on the type, concentration, or the like of an element that is included in each of the crushed pieces 3. Further, for example, for a metal structure 2 that is mounted on a vehicle, there may be a required physical property (a required range) such as required strength or a required standard, but concentration of the included metal element may vary within a range that satisfies the required physical property. Therefore, even when metal structures 2 satisfy the required physical property, crushed shapes of the metal structures 2 may be different. Therefore, in FIG. 3, as an example, in a case where a specific element is focused on, the crushed shape is stored for each material type in a case where the concentration of the element is relatively high (for example, an upper limit value of the concentration that satisfies the required physical property [required range]) and in a case where the concentration of the element is relatively low (for example, a lower limit value of the concentration that satisfies the required physical property [required range]).

However, there may be a concentration that satisfies the required physical property but is not actually used, or a concentration that is used but is used less frequently. That is, as described above, there may be a metal composition that satisfies the required physical property but is not actually used, a metal composition that is used but is rarely used, or the like. As an example, in FIG. 3, it is assumed that a crushed piece 3 of a material type with a relatively small concentration of a predetermined metal is not actually used even though the required physical property is satisfied, and that a crushed shape obtained by the FEM analysis is stored for the crushed piece 3 of the material type instead of a crushed shape obtained from an actual measurement. On the other hand, for a crushed piece 3 of a material type with, for example, a medium concentration (an element concentration is approximately midway between an upper and a lower limit of a range defined by the required physical property), it is assumed that a metal structure 2 of the material type is widely used and that a crushed shape may easily be obtained, and a crushed shape of an actually obtained crushed piece 3 is stored.

In this manner, the shape DB 15 associates a crushed shape of a crushed piece 3 determined by the virtual method with a material type of the crushed piece 3. Further, the shape DB 15 associates a crushed shape of a crushed piece 3 that has actually been obtained by actually crushing a metal structure 2 with a material type of the crushed piece 3. Therefore, in the example of the disclosure, the material type is associated with an actually obtained crushed shape or a crushed shape obtained by the virtual method. The former crushed shape is a shape that has been subjected to an actual crushing operation, and is therefore a shape that is more in line with an actual state. On the other hand, the latter crushed shape may be obtained by a virtual method, and thus the labor of obtainment may be suppressed and the number of obtainment may be greatly increased. Therefore, by using both crushed shapes, an accuracy of the machine learning model 17 using the shape DB 15 may be improved.

In a case where a plurality of cameras from the camera 32 (optical), camera 33 (infrared), or camera 34 (X-ray) are used, a plurality of pieces of input data are obtained. Therefore, the shape DB 15 may include a plurality of columns (as many as the number of cameras used) for storing the crushed shape of the crushed piece 3. A plurality of images obtained by capturing the same crushed piece 3 may, through processing (addition, subtraction, or another processing if any), be combined into one (image, piece of data, or the like) that may then be stored in one column of the shape DB.

Referring back to FIG. 2, the construction part 12 references the shape DB 15 and assigns a material type as a label to a crushed shape of a crushed piece 3 that has actually been obtained through the camera 32, 33, 34, for example. Accordingly, the crushed shape in an image obtained through the camera 32, 33, 34 is associated with the material type, for example. Then, the construction part 12 constructs the machine learning model 17 using the crushed shape labeled with the material type as teacher data. In this way, the machine learning model 17 used for sorting in the sorting system 1 may be constructed. The constructed machine learning model 17 is stored in the storage 18.

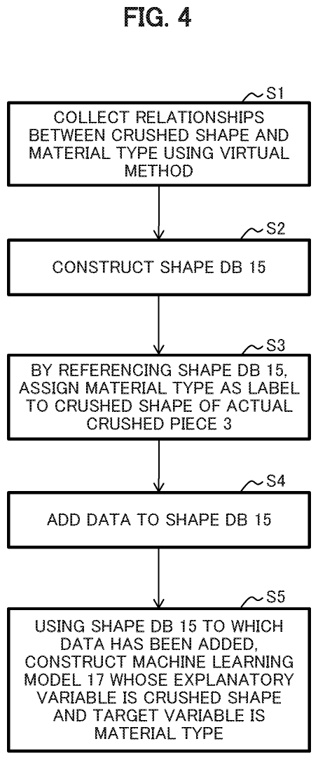

FIG. 4 is a flowchart showing a method of constructing the machine learning model 17 when labeling is performed. The construction (training) of the machine learning model 17 may be executed, for example, before material type determination of a crushed piece 3 using the material type determination system 10. The machine learning model 17 may be updated after the material type determination using the material type determination system 10 has started, for example, by adding data to the shape DB 15 for a crushed piece 3 using the determined first material type and the crushed shape of the crushed piece 3 as appropriate.

The method of constructing the machine learning model 17 when labeling is performed includes steps S1 to S5. Steps S1 to S5 are, for example, executed by the construction part 12.

In step S1, a relationship between a material type and a crushed shape is collected by a virtual method. As described above, the generative AI may be used to obtain a crushed shape predicted from a material type of a crushed piece 3. The virtual method is, for example, a method using FEM analysis or generative AI as described above. For example, a crushed shape may be determined, for example, by FEM analysis by modeling the crushing device, setting the material type of a metal, and performing plastic deformation analysis. A parameter other than the material type, such as a thickness, dimensions, or a size of the metal, may also affect the crushed shape. Therefore, the FEM analysis may be performed by setting the parameter other than the material type.

Further, in a case where the above-mentioned generative AI is used, the generative AI may, for example, be constructed by performing deep learning using actual crushed shapes and material types as training data. A model used for the generative AI may for example be a generative pre-trained transformer (GPT). By using the generative AI constructed in this manner, a material type may be estimated and output even when an unknown crushed shape is input. This makes it possible to collect a large number of relationships between the crushed shape and the material type.

The estimation of a crushed shape using the virtual method may be preferable in cases such as: a case where, for example, it is difficult to actually produce a crushed piece 3 as described above; and a case of a material type that meets a required physical property but is rarely available in practice (for example, the element concentration is the upper limit, the lower limit, or the like of a range defined by the required physical property) as described above.

In S2, the shape DB 15 is constructed by storing the relationship obtained in step S1. The storage is performed by associating the crushed shape with the material type. In step S3, a material type is assigned as a label to an actual crushed shape of a crushed piece 3 by referencing the shape DB 15. In this way, the actual crushed shape of a crushed piece 3 is associated with the material type that indicates the crushed shape.

In step S4, the data that has been labelled in step S3 (the relationship between the crushed shape and the material type) is added to the shape DB 15. In step S5, using the data-added shape DB 15, machine learning is performed with the crushed shape as an explanatory variable and the material type as a target variable, thereby constructing the machine learning model 17. A machine learning model used for training may, for example, be a model used for supervised learning, and specific examples thereof include regression analysis, a decision tree, and a neural network.

FIG. 5 is a schematic diagram of a product DB 16. In an embodiment shown in FIG. 4, the labeling may be performed using, for example, the product DB 16 shown in FIG. 5.

The product DB 16 is a database in which a material type of a crushed piece 3 (of a metal structure 2), information on a shape of the metal structure 2 from which the crushed piece 3 originates, and a shape of a characteristic portion of the crushed piece 3 generated by crushing the metal structure 2 are associated with each other for each metal structure 2 (a component, finished product, or the like). Therefore, the construction part 12 may detect a characteristic portion from a crushed shape of an actually obtained crushed piece 3 using the product DB 16 and use the corresponding material type for labeling.

A metal structure 2 includes a structure that is distinctive thereto. Therefore, the metal structure 2 may include a portion with excellent mechanical strength or a portion with poor mechanical strength. As a result, when the metal structure 2 is crushed by a crushing device, a portion with relatively low mechanical strength tends to disappear, while a portion with relatively high mechanical strength tends to remain. For example, when the metal structure 2 is a wheel that is a casting made of aluminum, the characteristic portion is a portion in a vicinity of the circumference of the wheel, which is particularly excellent in mechanical strength (high strength). For example, when the metal structure 2 is a door made of iron (mild steel), the characteristic portion is a portion in a vicinity of a corner of the door, which is particularly excellent in mechanical strength. In a crushed piece 3 obtained by crushing, a shape of a portion with excellent mechanical strength tends to be detected, and this shape may be said to be a structure characteristic of a metal structure 2 from which the crushed piece 3 is derived (the metal structure 2 from which the crushed piece 3 is generated). Therefore, the material type of a crushed piece 3 may be determined from the shape of the crushed piece 3 and the characteristic portion stored in the product DB 16.

Construction of the product DB 16 may be carried out, for example, by actually obtaining the metal structures 2. To be more specific, the obtained metal structures 2 are crushed by a crushing device, and the characteristic portions obtained thereby may be stored in the product DB 16. When a metal structure 2 is not actually available due to a reason such as not being commercially available, the metal structure 2 may be modelled by a 3D printer or the like using photographs, drawings, or the like of the metal structure 2 that is not available, and a characteristic portion obtained by crushing the model by a crushing device may be stored in the product DB 16. In one or more embodiments, the product DB 16 may be produced using information on an actual product that is a metal structure 2 (information obtainable from an actual object, information obtainable from a catalog or specifications, or the like).

Referring back to FIG. 2, in another embodiment, the construction part 12 constructs the machine learning model 17 using the crushed shape of the crushed piece 3 determined by the virtual method as an explanatory variable. In other words, unlike the embodiment shown in FIG. 4, labeling is not performed, and the machine learning model 17 is constructed using only the crushed shape obtained by the virtual method. By using the virtual method, a large number of crushed shapes may be prepared, and machine learning may be executed using a large amount of data.

FIG. 6 is a flowchart showing a method of constructing the machine learning model 17 in a case where labeling is not performed. In the example shown in FIG. 4, assigning a material type as a label to an actual crushed shape is performed. However, in the example shown in FIG. 6, labeling is not performed, and the shape DB 15 is constructed by storing only the relationship between the crushed shape and the material type obtained by the virtual method in the shape DB 15 (steps S1, S2).

Then, in step S11, the machine learning model 17 is constructed by using the shape DB 15 and performing learning with the crushed shape as the explanatory variable and the material type as the target variable. As a machine learning model used for training, the model described in the above-mentioned step S5 may be used.

Referring back to FIG. 2, in still another embodiment, the construction part 12 performs that following process: from a crushed shape determined by the virtual method, the construction part 12 detects a characteristic portion or an entire structure of a metal structure 2 stored in the product DB 16 and retrieves a corresponding material type from the product DB 16. In particular, for example, in a case where strength (shear strength or the like) is particularly large for a small metal structure 2, even after the metal structure 2 is crushed using a crushing device, most of the structure prior to crushing may remain as it is in the crushed piece 3. In this case, the corresponding material type may be determined from the entire structure of the metal structure 2 stored in the product DB 16. In this way, the material type may be estimated even when a crushed shape of an actual crushed piece 3 is not available.

The determination part 13 is a functional part that determines, from the machine learning model 17 and a crushed shape of an actually obtained crushed piece 3, a material type of the obtained crushed piece 3. By inputting the crushed shape to the machine learning model 17, the material type is output. In this way, the material type may be determined even for a metal structure including a composition with a low frequency of occurrence.

The determination part 13 determines a material type from a crushed shape of an actually obtained crushed piece 3 using, for example, the product DB 16 shown in FIG. 5. In addition, the determination part 13 confirms a material type of the crushed piece 3 based on a first material type determined using the product DB 16 and a second material type determined using the machine learning model 17. That is, the first material type and the second material type are determined as candidates of a material type, but the determined candidates of the material type are not transmitted to the control part 14 or the output part 19 at the time when the candidates are determined. The determination part 13 determines a final material type to be transmitted to the control part 14 and the output part 19 based on the first material type and the second material type. In this way, the material type may be determined from different viewpoints using the machine learning model 17 and the product DB 16, and thus accuracy of determination may be improved.

As a specific confirmation method, when the first material type and the second material type match each other, the determination part 13 confirms that the first material type and the second material type are the material type of the crushed piece 3. When the material types determined from different viewpoints match, reliability of the determined material types is considered to be high. Therefore, by determining the material type in this manner, material type determination accuracy may be improved.

On the other hand, when the first material type and the second material type are different from each other, the determination part 13 executes at least one of the following first process or second process. The first process is a process of again determining a material type of the crushed piece 3 for which the material type has been determined. The second process is a process of outputting a message to the output device 42 to prompt an operator (a user of the material type determination system 10) to perform reinspection. When the material types that are determined from different viewpoints are different, it may be considered that at least one of the first material type or the second material type is incorrect. In this case, material type determination accuracy may be improved by performing reinspection by the sorting system 1 or by performing reinspection by, for example, visual inspection by the operator. In this case, for example, the second process may be performed without performing the first process, the first process may be performed without performing the second process, or both the first process and the second process may be performed.

The control part 14 is a functional part that controls the sorter 41 according to the material type determined by the determination part 13. Specifically, the control part 14 controls an operation of the sorter 41 so as to store the crushed pieces 3 in different containers 35, 36 (FIG. 1) by material type of each crushed piece 3.

The output part 19 is a functional part that outputs the material type determined by the determination part 13 to the output device 42. By using the output part 19, the operator may be informed of the material type determined by the material type determination system 10, or the material type may be used in an external device (not shown).

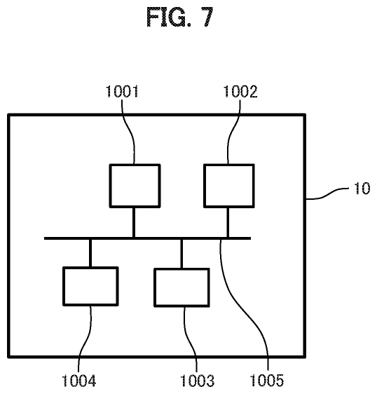

FIG. 7 is a block diagram showing a specific hardware configuration of the material type determination system 10 according to an embodiment of the disclosure. The material type determination system 10 is a device that controls operations of the material type determination system 10 and the sorting system 1, and executes at least a part of a method of producing metal materials 5 (to be described later), a material type determination method, and a sorting method of the disclosure. The material type determination system 10 is configured to include, for example, a central processing unit (CPU) 1001, a random access memory (RAM) 1002, a read only memory (ROM) 1003, an interface (I/F) 1004, and a bus 1005, or the like. The CPU 1001, RAM 1002, ROM 1003, and I/F 1004 are connected, for example, via the bus 1005. The material type determination system 10 is implemented by a predetermined control program (for example, a program to implement each of the above-described methods such as the method of producing metal materials 5 of the disclosure), which is stored in the ROM 1003, being loaded in the RAM 1002 and executed by the CPU 1001. Exchange of signals and information between the material type determining system 10 and various devices (the input device 40, the camera 32, 33, 34, the sorter 41, the output device 42, or the like) is performed through the I/F1004 in terms of hardware.

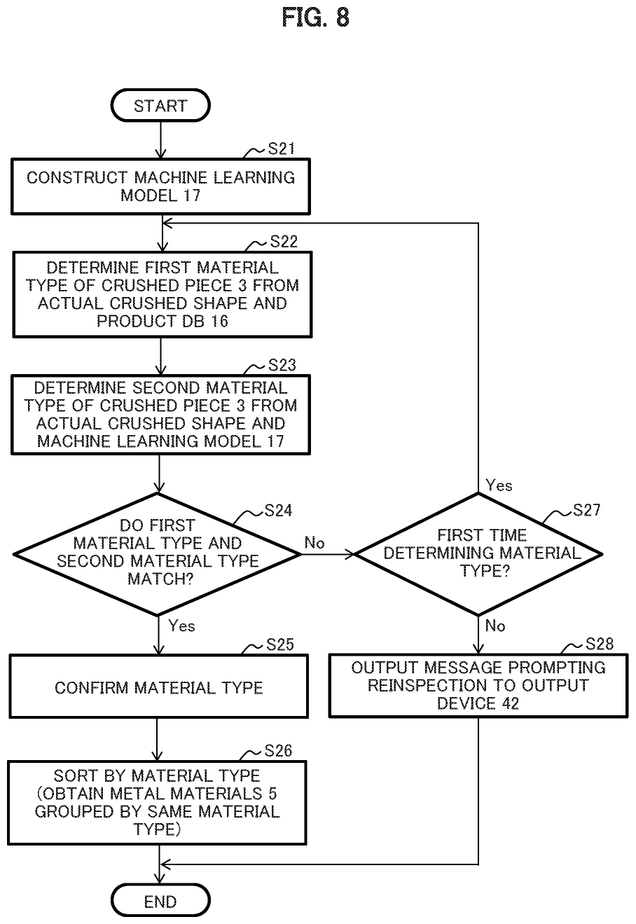

FIG. 8 is a flowchart showing the method of producing metal materials 5 of the disclosure (hereinafter, may simply be referred to as “production method of the disclosure”). The production method of the disclosure may also be referred to as a material type determination method of crushed pieces 3 or a sorting method of crushed pieces 3. The production method of the disclosure may be executed using the above-mentioned material type determination system 10 and the sorting system 1. Therefore, the above description is similarly applicable to the production method of the disclosure. The production method of the disclosure includes steps S21 to S28.

In step S21 (construction step), the above-mentioned machine learning model 17 is constructed. As described above, the machine learning model 17 is constructed from a crushed shape of a crushed piece 3 determined by the virtual method for each material type of crushed pieces 3 that are made of metal. As described above, the machine learning model 17 is a machine learning model with the crushed shape as the explanatory variable and the material type of the crushed piece 3 as the objective variable. Step S21 may be executed, for example, by the construction part 12.

In step S22, a crushed piece 3 moving on the belt conveyor 30 is photographed by the camera 31, 32, 33 (as described above, not all cameras 31, 32, and 33 may be used to photograph the crushed piece 3, and at least one of the camera 31, camera 32, or camera 33 may be used), and an actual crushed shape of the crushed piece 3 is captured. Then, the first material type of the crushed piece 3 is determined from the actual crushed shape and the product DB 16 (FIG. 5). The determination may be made, for example, based on the characteristic portion stored in the product DB 16. Step S22 may be executed by the determination part 13, for example. When the first material type may not be determined for a reason such as information not being stored in the product DB 16, the first material type may, for example, be regarded as unknown and the following step S23 may be performed.

In step S23 (determination step), by using the image captured in step S22, the second material type of the crushed piece 3, which has been obtained, is determined from the crushed shape of the crushed piece 3 that has actually been obtained and the machine learning model 17. For example, a material type is output by inputting the crushed shape to the machine learning model 17. Step S23 may be executed, for example, by the determination part 13.

In step S24, it is determined whether or not the first material type (including the case where the first material type is unknown), which has been determined in step S22, and the second material type, which has been determined in step S23, match each other. When the first and second material types match (Yes), the first material type and the second material type are confirmed as the material type of the crushed piece 3 (step S25, determination step). Steps S24 and S25 may be executed, for example, by the determination part 13.

The crushed piece 3 whose material type has been confirmed is sorted by material type according to the material type determined in step S25 (step S26, sorting step). As a result, metal materials 5 grouped by material type are obtained. The metal materials 5 may, for example, be reused as recycling material. Step S26 may be executed by, for example, the control part 14 and the sorter 41.

On the other hand, in step S24, when the first material type and the second material type do not match each other (No; including the case where the first material type is unknown), the process proceeds to step S27. In step S27, it is determined whether the material type determination for the crushed piece 3, for which the first material type and the second material type have been determined, has been carried out for the first time. Here, the determination of the first material type and the determination of the second material type are collectively counted as one time. Step S27 may be executed, for example, by the determination part 13.

As a result of the determination of step S27, when the material type determination has been carried out for the first time (Yes), step S22 and subsequent steps are repeated. Accordingly, material types (the first material type and the second material type) are determined again for the crushed piece 3 for which the material type has been determined. Step S27 may be executed, for example, by the determination part 13. When the material type determination has been for the second time or more (No), a message prompting the operator to perform reinspection is output to the output device 42 (step S28). This allows the material type to be determined, for example, by visual inspection by the operator. Step S28 may be executed, for example, by the determining part 13 and the output part 19.

An object of the disclosure is to provide a material type determination system and a metal material production method capable of determining a material type even for a metal structure whose composition has a low frequency of occurrence.

According to the disclosure, it is possible to provide a material type determination system and a metal material production method that are capable of determining a material type even for a metal structure whose composition has a low frequency of occurrence.

### ASPECTS OF THE DISCLOSURE

A first aspect of the disclosure provides a material type determination system that includes a construction part and a determination part. The construction part is configured to: determine, for each material type of a crushed piece that is made of metal, a crushed shape of the crushed piece by a virtual method; and, from the determined crushed shape for each material type, construct a machine learning model whose explanatory variable is a crushed shape and whose target variable is a material type of the crushed piece. The determination part is configured to determine, from the machine learning model and a crushed shape of the crushed piece that has actually been obtained, a material type of the obtained crushed piece.

A second aspect of the disclosure provides the material type determination system according to the first aspect, further including a shape database. The shape database is configured to store therein a crushed shape of a crushed piece determined by the virtual method and a material type of the crushed piece in association with each other. The construction part is configured to: refer to the shape database to assign a material type as a label to the crushed shape of the crushed piece that has actually been obtained; and construct the machine learning model by using the crushed shape labelled with the material type as training data.

A third aspect of the disclosure provides the material type determination system according to the second aspect, in which the shape database is further configured to store therein a crushed shape of a crushed piece that has actually been obtained and a material type of the crushed piece in association with each other.

A fourth aspect of the disclosure provides the material type determination system according to the first aspect, further including a product database. The product database is configured to store therein a material type of the crushed piece, information on a shape of a metal structure from which the crushed piece is derived, and a shape of a characteristic portion of the crushed piece created by crushing the metal structure in associated with each other. The determination part is configured to: determine a material type from the crushed shape of the crushed piece that has actually been obtained by using the product database; and confirm a material type of the crushed piece based on a first material type determined using the product database and a second material type determined using the machine learning model.

A fifth aspect of the disclosure provides the material type determination system according to the fourth aspect, in which, in response to the first material type and the second material type being a match, the determination part is configured to confirm that the first material type and the second material type are the material type of the crushed piece. In response to the first material type being different from the second material type, the determination part is configured to execute at least one of: determining again a material type of the crushed piece whose material type has been determined; or outputting a message prompting an operator to perform reinspection to an output device.

A sixth aspect of the disclosure provides the material type determination system according to the first aspect, further including an output part. The output part is configured to output the material type determined by the determination part to an output device.

A seventh aspect of the disclosure provides a sorting system including the material type determination system according to the first aspect and a sorter. The sorter is configured to sort the crushed pieces by material type in accordance with the material type determined by the determination part.

An eighth aspect of the disclosure provides a metal material production method. The method includes: determining, for each material type of a crushed piece that is made of metal, a crushed shape of the crushed piece by a virtual method; from the determined crushed shape for each material type, constructing a machine learning model whose explanatory variable is a crushed shape and whose target variable is a material type of the crushed piece; determining, from the machine learning model and a crushed shape of the crushed piece that has actually been obtained, a material type of the obtained crushed piece; and sorting crushed pieces by material type in accordance with a material type determined using the machine learning model for each of the crushed pieces to obtain metal materials grouped by material type.

What is claimed is:

1. A material type determination system, comprising:
a hardware processor, wherein
the hardware processor is configured, as a construction part, to:
determine, for each material type of a crushed piece that is made of metal, a crushed shape of the crushed piece by a virtual method; and,
from the determined crushed shape for each material type, construct a machine learning model whose explanatory variable is a crushed shape and whose target variable is a material type of the crushed piece, and
the hardware processor is configured, as a determination part, to:
determine, from the machine learning model and a crushed shape of the crushed piece that has actually been obtained, a material type of the obtained crushed piece.

2. The material type determination system according to claim 1, further comprising:
a shape database that is configured to store therein a crushed shape of a crushed piece determined by the virtual method and a material type of the crushed piece in association with each other, wherein
the hardware processor is configured, as the construction part, to:
refer to the shape database to assign a material type as a label to the crushed shape of the crushed piece that has actually been obtained; and
construct the machine learning model by using the crushed shape labelled with the material type as training data.

3. The material type determination system according to claim 2, wherein
the shape database is further configured to store therein a crushed shape of a crushed piece that has actually been obtained and a material type of the crushed piece in association with each other.

4. The material type determination system according to claim 1, further comprising:
a product database that is configured to store therein a material type of the crushed piece, information on a shape of a metal structure from which the crushed piece is derived, and a shape of a characteristic portion of the crushed piece created by crushing the metal structure in associated with each other, wherein
the hardware processor is configured, as the determination part, to:
by using the product database, determine a material type from the crushed shape of the crushed piece that has actually been obtained; and
confirm a material type of the crushed piece based on a first material type determined using the product database and a second material type determined using the machine learning model.

5. The material type determination system according to claim 4, wherein
in response to the first material type and the second material type being a match, the hardware processor is configured, as the determination part, to confirm that the first material type and the second material type are the material type of the crushed piece, and
in response to the first material type being different from the second material type, the hardware processor is configured, as the determination part, to execute at least one of:
determining again a material type of the crushed piece whose material type has been determined; or
outputting a message prompting an operator to perform reinspection to an output device.

6. The material type determination system according to claim 1, wherein
the hardware processor is configured, as an output part, to output the material type determined by the determination part to an output device.

7. A sorting system, comprising:
the material type determination system according to claim 1; and
a sorter configured to sort the crushed pieces by material type in accordance with the material type determined by the determination part.

8. A metal material production method, comprising:
determining, for each material type of a crushed piece that is made of metal, a crushed shape of the crushed piece by a virtual method;
from the determined crushed shape for each material type, constructing a machine learning model whose explanatory variable is a crushed shape and whose target variable is a material type of the crushed piece;
determining, from the machine learning model and a crushed shape of the crushed piece that has actually been obtained, a material type of the obtained crushed piece; and
sorting crushed pieces by material type in accordance with a material type determined using the machine learning model for each of the crushed pieces to obtain metal materials grouped by material type.
